(19) United States
(12) Patent Application Publication
(10) Pub. No.: US 2012/0073451 A1
(43) Pub. Date: Mar. 29, 2012

(54) BAKING PAN

(76) Inventors: George McConnell Davison, III, Pittsburgh, PA (US); Peter Arthur Meier, Pittsburgh, PA (US); Jason Reed Rogge, Belle Vernon, PA (US); Colin Derek Curry, Pittsburgh, PA (US)

(21) Appl. No.: 12/890,149

(22) Filed: Sep. 24, 2010

(51) Int. Cl. A23P 1/10

(52) U.S. Cl. 99/426

(57) ABSTRACT

A baking pan includes a body, a cavity formed in the body for receiving batter, and a member positioned within the cavity for supporting a filling material in the batter.

### BACKGROUND

The present invention relates to baking pans.

Baking pans, such as cupcake pans, receive batter to create baked goods having a desired shape and size. However, there is typically no easy and efficient way for a baker to put a filling within one of the baked goods. Instead, the filling is either mixed with the batter before baking or is placed in the baked good after baking. If the filling is mixed with the batter, there is no mechanism to hold the filling in a particular position relative to the batter. As such, the filling may float around in the batter and end up protruding from the bottom, side, or top of the baked good. Adding the filling after baking can be a time-consuming process that requires the baker to carve out a portion of the baked good and carefully insert the filling by hand.

### SUMMARY

In one embodiment, the invention provides a baking pan including a body and a cavity formed in the body for receiving batter. The cavity is defined in part by a bottom surface. The baking pan also includes a post positioned within the cavity for supporting a filling material in the batter. The post extends from the bottom surface.

In another embodiment, the invention provides a cupcake pan including a body and a plurality of cavities formed in the body for receiving batter. Each cavity is defined in part by a bottom surface. The cupcake pan also includes a plurality of posts. Each post is positioned within one of the plurality of cavities for supporting a filling material in the batter. Each post extends from a corresponding bottom surface.

In yet another embodiment, the invention provides a baking pan including a body, a cavity formed in the body for receiving batter, and a member positioned within the cavity for supporting a filling material in the batter.

Other aspects of the invention will become apparent by consideration of the detailed description and accompanying drawings.

### BRIEF DESCRIPTION OF THE DRAWINGS

FIG. 1 is a top perspective view of a baking pan embodying the present invention.

FIG. 2 is an exploded bottom perspective view of the baking pan shown in FIG. 1.

FIG. 3 is a cross-sectional view of the baking pan taken along section line 3-3 of FIG. 1.

FIG. 4 is a top perspective view of another embodiment of a baking pan.

FIG. 5 is an enlarged view of a post for use with the baking pan shown in FIG. 4.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

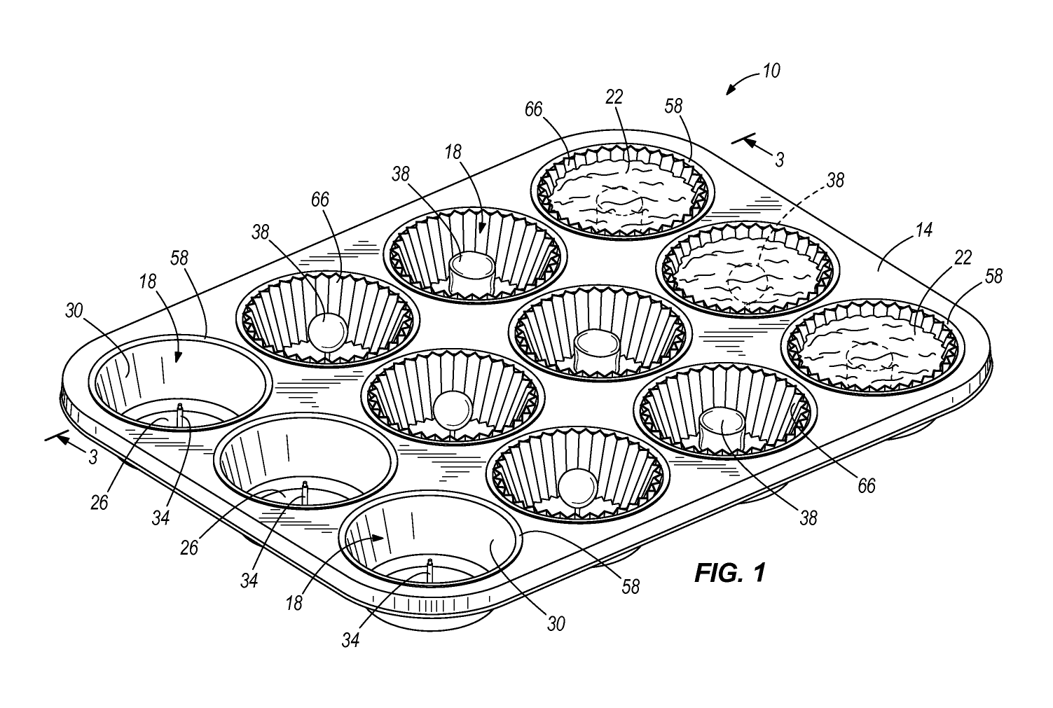

FIGS. 1-3 illustrate a baking pan 10 embodying the invention. In the illustrated embodiment, the baking pan 10 is a cupcake pan suitable for baking twelve cupcakes or muffins. In other embodiments, the cupcake pan 10 may be configured to bake fewer or more cupcakes or muffins and/or may be configured to bake cupcakes or muffins of different shapes and sizes. In still other embodiments, the baking pan 10 may be a pan suitable for baking other types of baked goods such as, for example, cakes, pies, breads, brownies, or the like.

As shown in FIG. 1, the cupcake pan 10 includes a body 14 and a plurality of cavities 18 formed in the body 14. The illustrated body 14 is generally rectangular in shape and composed of steel. In other embodiments, the body 14 may be a different shape and/or may be composed of other materials. In some embodiments, the body 14 may be coated with a non-stick coating to inhibit baked goods from sticking to the body 14 during baking.

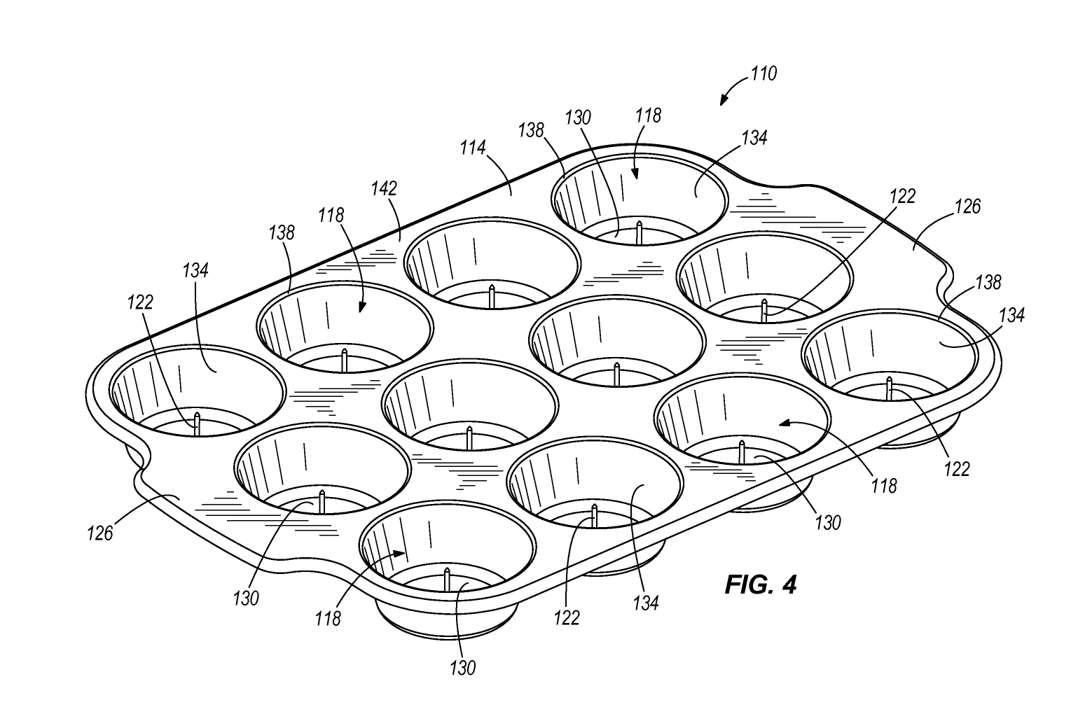

The cavities 18 are configured to receive batter 22 for baking, for example, cupcakes, muffins, or the like. Each cavity 18 is generally cylindrical in shape and defined by a bottom surface 26 and a sidewall 30. In the illustrated embodiment, the bottom surfaces 26 and the sidewalls 30 are manufactured as separate cups that are permanently welded, brazed, or otherwise secured to the body 14. In other embodiments, such as the embodiment discussed below with reference to FIG. 4, the bottom surfaces 26 and the sidewalls 30 may be integrally formed as a single piece with the body 14. In some embodiments, the cupcake pan 10 may include cavities that are other shapes and/or sizes relative to the illustrated cavities 18 or to each other. For example, the cupcake pan 10 may include semi-spherical cavities that are defined by semi-spherically-shaped bottom surfaces.

The illustrated cupcake pan 10 also includes a plurality of posts 34. Each post 34 is positioned within one of the cavities 18 for supporting a filling material 38 in the batter 22. For example, the posts 34 may support fruit (e.g., cherries, strawberries, apple pieces, raspberries, etc.), candies (e.g., chocolates, marshmallows, gummy worms, gumballs, etc.), nuts (e.g., walnuts, almonds, cashews, etc.), or the like within the cavities 18. During baking, the filling materials 38 are suspended within the batter 22 on the posts 34 such that the filling materials 38 become baked inside the batter 22, creating fruit-, candy-, or nut-filled baked goods. In some embodiments, if the filling material 38 is, for example, a chocolate or a marshmallow, the filling material 38 may melt during baking to create a creamy or gooey center.

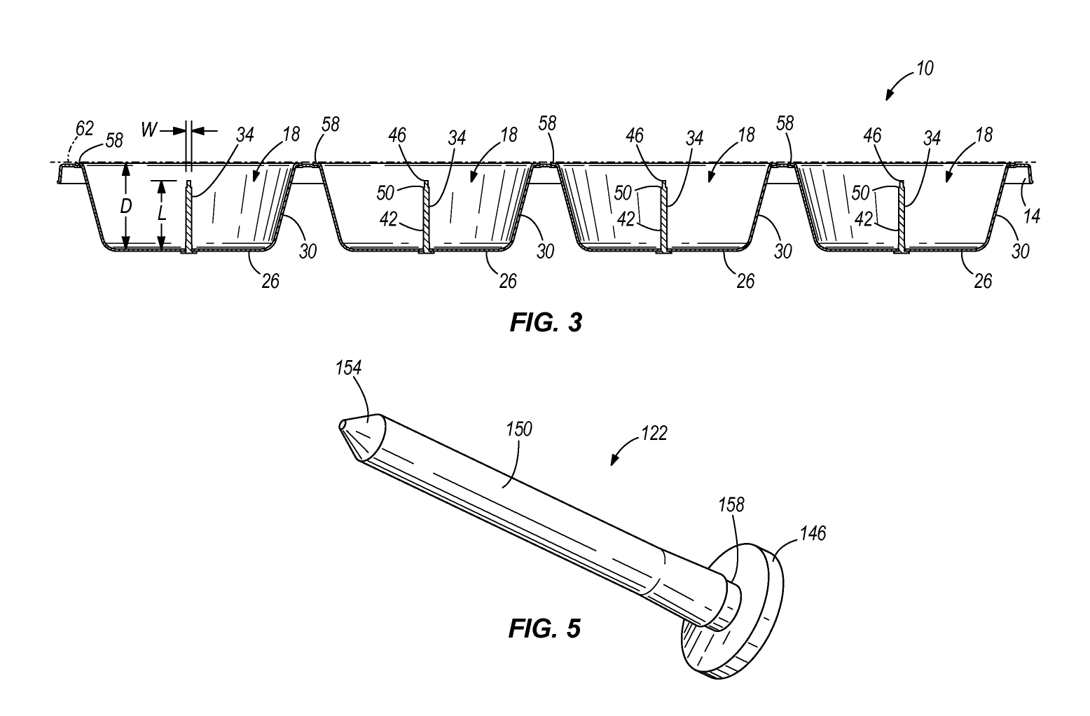

As shown in FIGS. 1-3, the posts 34 extend generally perpendicularly from the bottom surfaces 26 and into the cavities 18 to support the filling materials 38. In the illustrated embodiment, the posts 34 are elongated cylindrical posts or members having a circular cross-section. Referring to FIG. 3, a length L of each post 34 is over ten times greater than a diameter W of each post 34. In other embodiments, the posts 34 may have other cross-sectional shapes (e.g., square, triangular, hexagonal, oblong, etc.) and/or a ratio of the length L to the diameter/width W of each post 34 may be larger or smaller than ten.

In the illustrated embodiment, a single post 34 is positioned within each cavity 18 and extends from a center of the bottom surface 26. As such, the filling materials 38 are spaced apart from the bottom surfaces 26 and from the sidewalls 30 when supported by the posts 34. That is, the filling materials 38 do not directly contact the bottom surfaces 26 or the sidewalls 30 during baking. In some embodiments, the filling materials 38 may be slid completely down the posts 34 to contact and rest on the bottom surfaces 26 during baking. In other embodiments, multiple posts 34 may be positioned within each cavity 18 and/or some of the cavities 18 may not include posts 34.

Each post 34 includes a shaft 42 and a tip 46. The shaft 42 extends from the bottom surface 26. The tip 46 is positioned on an end of the shaft 42 opposite the bottom surface 26. The tips 46 pierce or penetrate the filling materials 38 such that the posts 34 extend through at least a portion of the materials 38 to support the materials 38. In the illustrated embodiment, each tip 46 has a cross-sectional area that is less than a cross-sectional area of the corresponding shaft 42 such that a step 50 is formed between the tip 46 and the shaft 42. In some embodiments, the steps 50 act as shelves or stops for positioning the filling materials 38 on the posts 34. In other embodiments, such as the embodiment illustrated in FIG. 5, the tips 46 of the posts 34 may be tapered. In still other embodiments, a portion of each post 34 may have a generally larger cross-sectional area such that the filling materials 38 may rest on the posts 34 without being pierced by the tips 46.

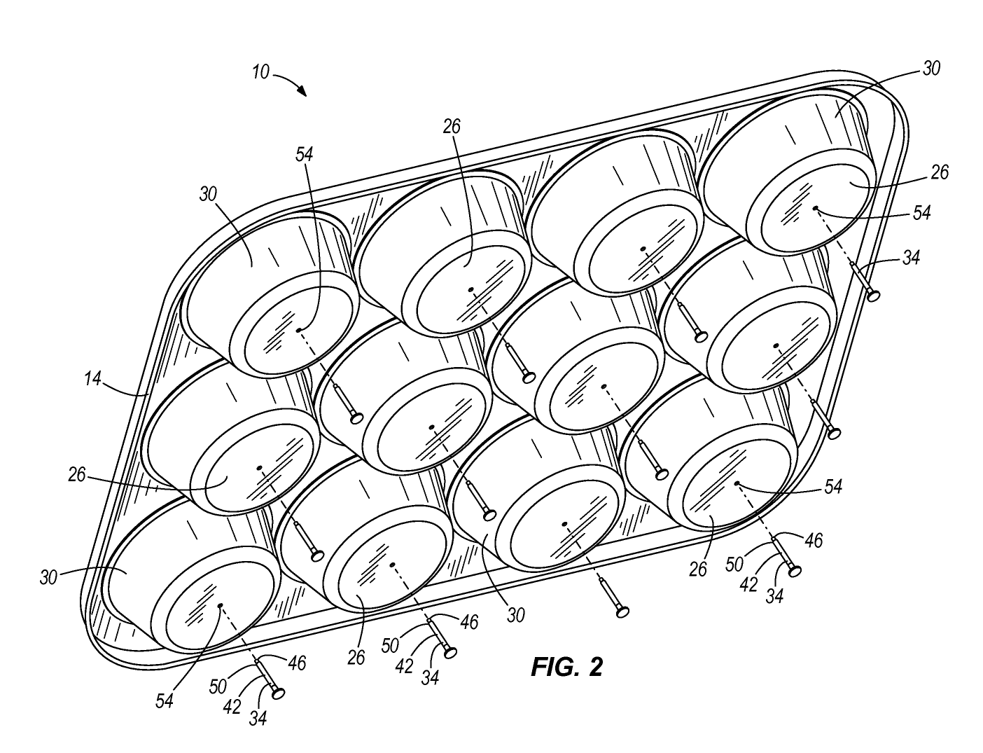

As shown in the embodiment of FIG. 2, each bottom surface 26 defines an opening 54 at the center of the bottom surface 26. In this embodiment, during manufacture and assembly of the cupcake pan 10, the posts 34 are received (e.g., inserted) in the openings 54 to extend into the cavity 18. The posts 34 are then spot welded to the bottom surface 26 to permanently secure the posts 34 in place. In other embodiments, the posts 34 may be secured to the bottom surfaces 26 using other suitable coupling means. In still other embodiments, the posts 34 may be removably coupled to the bottom surfaces 26. In such embodiments, a user may position the posts 34 within the cavities 18 when he/she desires to make baked goods with filling materials 38 and may remove the posts 34 when he/she desires to make baked goods without filling materials 38.

As shown in FIG. 3, each cavity 18 has an upper edge 58 lying in a plane 62. In the illustrated embodiment, the upper edges 58 of the cavities 18 all lie in the same plane 62. In other embodiments, the upper edges 58 of the cavities 18 may lie in different planes. The illustrated posts 34 extend from the bottom surfaces 26 toward the plane 62, but do not extend beyond the plane 62. Instead, in the illustrated embodiment, the tips 46 of the posts 34 are spaced apart from the plane 62. In some embodiments, the posts 34 may extend more than 75% of the distance from the bottom surfaces 26 toward the plane 62 (i.e., the length L of each post 34 may be more than 75% of a depth D of each cavity 18). In the illustrated embodiment, the posts 34 extend approximately 90% of the distance from the bottom surfaces 26 toward the plane 62 (i.e., the length L of each post 34 is approximately 90% of the depth D of each cavity 18). Such an arrangement facilitates storage of the cupcake pan 10 by providing a relatively flat upper surface. Such an arrangement also reduces the possibility of breaking or otherwise damaging the posts 34.

During use, if desired, a cupcake liner 66 (FIG. 1) may be positioned within each cavity 18. As the cupcake liners 66 are inserted into the cavities 18, the posts 34 pierce holes through the liners 66. The cupcake pan 10 may alternatively be used without the liners 66. As shown in FIG. 1, a filling material 38 is positioned on each post 34 to support the filling material 38 in the corresponding cavity 18. The posts 34 pierce or otherwise engage the filling materials 38 to support the materials 38 apart from the bottom surfaces 26 and the sidewalls 30. Batter 22 is then poured into the cavities 18 such that the filling materials 38 are suspended within the batter 22. Once filled, the cupcake pan 10 is placed in an oven or other suitable machine for baking.

FIG. 4 illustrates another embodiment of a baking pan 110. Similar to the baking pan 10 discussed above with reference to FIGS. 1-3, the illustrated baking pan 110 is a cupcake pan that includes a body 114, a plurality of cavities 118 formed in the body 114, and a plurality of posts 122 for supporting filling material. In the illustrated embodiment, the body 114 includes handles 126 to facilitate grasping and holding the cupcake pan 110. The illustrated handles 126 are integrally formed as a single piece with the body 114, but may alternatively be separate components that are permanently or removably coupled to the body 114.

Similar to the cavities 18 discussed above, each of the illustrated cavities 118 is defined by a bottom surface 130 and a sidewall 134 and is configured to receive batter. In the illustrated embodiment, the bottom surfaces 130 and the sidewalls 134 are integrally formed as a single piece with the body 114. As such, upper edges 138 of the cavities 118 are coplanar with an upper surface 142 of the body 114.

FIG. 5 illustrates one of the posts 122 of the cupcake pan 110 (FIG. 4) in more detail. The illustrated post 122 includes a head 146, a shaft 150, and a tip 154. The head 146 has a significantly larger diameter than the shaft 150 and the tip 154. A groove 158 is formed between the head 146 and the shaft 150 such that, when the post 122 is received (e.g., inserted) in an opening in the bottom surface 126 (FIG. 4) of the pan 110, the post 122 snap-fits in place. The large-diameter head 146 inhibits the post 122 from being pushed entirely through the opening. In the illustrated embodiment, the tip 154 of the post 122 is tapered to facilitate piercing the filling material. As such, the tip 154 has a smaller cross-sectional area than the shaft 150. Although not shown, the illustrated post 122 may also be used with the cupcake pan 10 shown in FIGS. 1-3.

Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A baking pan comprising:
a body;
a cavity formed in the body for receiving batter, the cavity defined in part by a bottom surface; and
a post positioned within the cavity for supporting a filling material in the batter, the post extending from the bottom surface.

2. The baking pan of claim 1, wherein the post is configured to support the filling material such that the filling material is spaced apart from the bottom surface.

3. The baking pan of claim 1, wherein the cavity is defined in part by a sidewall, and wherein the post is configured to support the filling material such that the filling material is spaced apart from the sidewall.

4. The baking pan of claim 1, wherein the post extends from a center of the bottom surface.

5. The baking pan of claim 1, wherein the post extends generally perpendicularly from the bottom surface into the cavity.

6. The baking pan of claim 1, wherein the bottom surface defines an opening, and wherein the post is received in the opening and extends into the cavity.

7. The baking pan of claim 1, wherein the post is welded to the bottom surface.

8. The baking pan of claim 1, wherein the cavity has an upper edge lying in a plane, and wherein the post does not extend beyond the plane.

9. The baking pan of claim 8, wherein the post includes a tip opposite the bottom surface, and wherein the tip of the post is spaced apart from the plane.

10. The baking pan of claim 1, wherein the post includes a shaft extending from the bottom surface and a tip opposite the bottom surface, and wherein a cross-sectional area of the tip is less than a cross-sectional area of the shaft.

11. A cupcake pan comprising:
a body;
a plurality of cavities formed in the body for receiving batter, each cavity defined in part by a bottom surface; and
a plurality of posts, each post positioned within one of the plurality of cavities for supporting a filling material in the batter, each post extending from a corresponding bottom surface.

12. The cupcake pan of claim 11, wherein each post is configured to support the filling material such that the filling material is spaced apart from the corresponding bottom surface.

13. The cupcake pan of claim 11, wherein each cavity is defined in part by a sidewall, and wherein each post is configured to support the filling material such that the filling material is spaced apart from a corresponding sidewall.

14. The cupcake pan of claim 11, wherein each post extends from a center of the corresponding bottom surface.

15. The cupcake pan of claim 11, wherein each post extends generally perpendicularly from the corresponding bottom surface.

16. The cupcake pan of claim 11, wherein a single post is positioned within each cavity.

17. The cupcake pan of claim 11, wherein each bottom surface defines an opening, and wherein each post is received in the opening of the corresponding bottom surface and extends into the one of the plurality of cavities.

18. The cupcake pan of claim 11, wherein each post is welded to the corresponding bottom surface.

19. The cupcake pan of claim 11, wherein each cavity has an upper edge lying in a plane, and wherein the plurality of posts does not extend beyond the plane.

20. The cupcake pan of claim 11, wherein each post includes a shaft extending from the bottom surface and a tip opposite the bottom surface, and wherein a cross-sectional area of the tip is less than a cross-sectional area of the shaft.

21. A baking pan comprising:
a body;
a cavity formed in the body for receiving batter; and
a member positioned within the cavity for supporting a filling material in the batter.

22. The baking pan of claim 21, wherein the cavity is defined in part by a bottom surface and the member is positioned to support the filling material apart from the bottom surface.

23. The baking pan of claim 22, wherein the cavity is defined in part by a sidewall and the member is positioned to support the filling material apart from the bottom surface and the sidewall.

24. The baking pan of claim 21, wherein the cavity is defined in part by a sidewall and the member is positioned to support the filling material apart from the sidewall.

25. The baking pan of claim 21, wherein the body comprises a plurality of cavities.

26. The baking pan of claim 21, wherein the member extends from the body into the cavity.
